(19) United States
(12) Patent Application Publication
(10) Pub. No.: US 2007/0240583 A1
(43) Pub. Date: Oct. 18, 2007

(54) Roaster with a Door on an Upper Portion

(76) Inventor: Ik-No Lee, Seoul (KR)

Correspondence Address: JONES, TULLAR & COOPER, P.C., P.O. BOX 2266 EADS STATION, ARLINGTON, VA, 22202, US

(21) Appl. No.: 11/587,147

(22) PCT Filed: Apr. 22, 2005
(86) PCT No.: PCT/KR05/01173

§ 371 Date: Oct. 20, 2006

(30) Foreign Application Priority Data
Apr. 23, 2004 (KR) 10-2004-0028343
Apr. 21, 2005 (KR) 10-2005-0033210
Apr. 21, 2005 (KR) 10-2005-0033196

(51) Int. Cl. A47J 37/06

(52) U.S. Cl. 99/325; 99/422

(57) ABSTRACT

Disclosed is a roaster with an improved door structure and an improved charcoal ignition structure. The roaster includes a roaster box having a pair or guides fixed to an upper portion thereof; a heat generation installed in the roaster box to generate heat; a meat fixing means installed in the roaster box to fix meat to be cooked by heat generated from the heat generation device; a carrying means mounted to the guides to be horizontally movable; and a door mounted to the carrying means and moving horizontally together with the carrying means to open or close the roaster box. The door increase inner pressure in the box and restricts gravy evaporation. The door has stable movement structure and easy separation from the box since it is just placed on the carrying means. The door has a cooling function to intercept hot air in the box.

### TECHNICAL FIELD

The present invention relates to a roaster, and more particularly to a roaster with an improved door structure and an improved charcoal ignition structure.

### BACKGROUND ART

Generally, a roaster is installed in the center of a table and used for cooking by use of a heat source such as gas or charcoal with a grill or a pan mounted thereon. Such a roaster is additionally provided with a smoke inhaling device at a side or an upper portion in order to inhale smoke or oil particles.

However, such a conventional roaster remarkably decreases pressure above meat to be cooked while inhaling smoke, resulting in promoting evaporation of gravy and causing the meat to be dried.

Meanwhile, a grill is mainly used for making perfume of combustion gas be soaked into meat to be cooked. However, the grill causes pollution of indoor air since it cannot perfectly suppress generation of smoke. In addition, oils dropped through the grill are incompletely combusted and adhered to the meat or grill, causing the generation of car-cinogenic substances and requiring frequent exchange of grill.

In order to solve the above problems, a roaster using radiant heat and a roaster equipped with a door on an upper portion have been proposed.

A conventional roaster using radiant heat is generally used for roasting meat with seasonings since perfume of combustion gas is not soaked into the meat, so its use is limited. In addition, a roaster equipped with a door on an upper portion generally has a hole in an upper portion so as to discharge combustion gas. However, such a combustion gas discharging hole discharges combustion gas as soon as the gas is generated, which results in a great amount of heat loss, does not allow the meat to be cooked by the combustion gas, and causes a great temperature difference in the roaster to make the meat not cooked regularly. Reluctantly, the roaster equipped with a door on an upper portion is used only as an infrared roaster in which a skewer is put on the meat and the meat is rotated. However, such a rotation-type roaster is inconvenient in mounting or detaching the meat (see Korean Patent Laid-open Publication No. 10-2002-0050611).

In addition, a sealing-type roaster equipped with a door and whose upper portion is completely closed has been proposed. Korean Utility Model Registration No. 20-0206887 discloses a roaster with a door that is opened or closed by means of rollers. This roaster has a problem that the door is held between guides or dragged on the table and thus not willing to move when being opened or closed since the door rolls in direct contact with rollers and the rollers are installed just in the roaster box. In addition, the door is supported by only the guides and the rollers while moving and not provided with a separate restraining means, so the door is apt to easily depart out during movement, which is so inconvenient.

Meanwhile, the conventional roasters have a plurality of holes in upper and lower portions of the roaster box to cool the box by means of convection, or prevent overheat of the box by using adiabatic materials. However, cooling by convection gives in-sufficient cooling effects since there is no means to promote convection, while cooling using adiabatic materials tends to be less used in the point that the adiabatic materials themselves are harmful to the human body.

Furthermore, the conventional roaster equipped with a door has no cooling means in the door that is most influenced by heat, so there are problems of burns or inferior cooking circumstance caused by the heated door.

Meanwhile, in case of the conventional roaster having a charcoal ignition device, a gas burner and an air blower are provided in a lower portion of the roaster, and a charcoal container is installed above them.

Such a conventional charcoal ignition device has drawbacks that the eyes are smarting and ashes are seriously flying when charcoal is ignited indoors. In order to solve such problems, the conventional roaster employs a roasting pan instead of a grill so as to prevent dispersion of gas and flying of ashes. However, the main purpose of using charcoal in cooking is to smoke-dry meat by means of the combustion gas of charcoal, so such smoke-drying effect is remarkably reduced if the roasting pan is used.

Korean Patent Registration No. 10-323331 discloses a charcoal ignition device for a roaster, which uses charcoal put in a charcoal container. Generally, incomplete combustion occurs due to temperature deficiency at a border between a fired surface of charcoal and an unfired surface of charcoal. However, this charcoal ignition device does not uniformly distribute high-temperature combustion gas on a charcoal surface to be fired, causing the generation of harmful gas such as incomplete combustion gas that makes the eyes smarting.

### DISCLOSURE OF INVENTION

Technical Problem

The present invention is designed to solve the problems of the prior art, and therefore an object of the invention is to provide a roaster capable of increasing inner pressure of a roaster box by combustion gas and restraining evaporation of gravy during cooking by installing an openable door on an upper portion of the roaster box.

Another object of the invention is to provide a roaster in which a movable carrying means is horizontally installed in a roaster box and then a door is placed on the carrying means so that the door may move in a very stable way and be easily detached from the roaster box, which allows easy repair, exchange and cleaning of the door.

Still another object of the invention is to provide a roaster that adds a cooling function to the door so that heat of the charcoal fire generated during the cooking procedure is not transferred to users, thereby preventing the users from feeling inconvenience getting burned due to high temperature of the charcoal fire and also allowing easy cleaning since oil adhered to the door is rapidly cooled.

Further another object of the invention is to provide a roaster whose sidewalls are cooled to give agreeable cooking environments to users and to be capable of efficiently cooling the roaster box by means of forced air circulation manner without using any adiabatic material.

Still another object of the invention is to provide a roaster in which a heat guide plate for guiding heat in the roaster box is installed to make its one end be inserted in or drawn out through the roaster box so that the heat guide plate may not be bent or deformed though it is expanded by high temperature.

Still further another object of the invention is to provide a roaster provided with a charcoal ignition device that ignites charcoal directly by using a burner to eliminate any inconvenience of moving a fired charcoal from outside, that continuously supply air to the fired charcoal to induce complete combustion by generating airflow near a lower portion of the charcoal, and that thus minimizes the generation of harmful gas such as carbon monoxide.

Technical Solution

In order to accomplish the above object, the present invention provides a roaster, which includes a roaster box having a pair of guides fixed to an upper portion thereof;

a heat generation installed in the roaster box to generate heat; a meat fixing means installed in the roaster box to fix meat to be cooked by heat generated from the heat generation device; a carrying means mounted to the guides to be horizontally movable;

and a door mounted to the carrying means and moving horizontally together with the carrying means to open or close the roaster box.

The carrying means may includes a pair of sliders mounted to the guides respectively to be horizontally slidable thereon; and a door support coupled to the pair of sliders to move horizontally together with the sliders.

Preferably, the door support may includes a seating portion with a predetermined width on which each end of the door is seated; and door restricting portions vertically formed on front and rear ends of the seating portion to restrict the door seated on the seating portion not to deviate in front or rear direction, wherein the door is separated from the door support by behavior of lifting up the door.

In addition, it is preferred that the guides are extended out of the roaster box by a predetermined length in a direction that the door is opened, and the sliders are supported by the extensions of the guide when the door is completely opened, whereby the door keeps a state horizontally supported to the guides when the door is completely opened.

At this time, the door preferably has a predetermined inner space where air is introduced in or discharged out.

In addition, an air supply means for supplying air to the inner space of the door may be installed to the roaster box.

Preferably, the air supply means includes a blower fixed to the roaster box to generate airflow by means of an external power source; and an air supply path for transferring the air generated from the blower toward the door, wherein the door has a communication hole that communicates the inner space of the door with the air supply path when the door is completely closed, and a discharge hole that communicates the inner space of the door with an external air, whereby, when the door is completely closed, the air supplied from the air supply means is supplied to the inner space of the door through the communication hole, and then discharged out through the discharge hole.

Preferably, the door includes a quadrangular frame having an airflow space therein; and upper and lower glasses coupled to upper and lower portions of the quadrangular frame, wherein the inner space of the door is formed between the quadrangular frame and the upper and lower glasses, wherein the communication hole is formed in a front side of the quadrangular frame, and the discharge hole is formed in a rear side of the quadrangular frame, and wherein the air introduced through the communication hole passes the inner space of the door as well as the airflow space in the quadrangular frame and is then discharged out.

Preferably, the roaster further includes a first sensor for sensing a state that the door is completely closed, wherein the air supply means supplies air when the first sensor senses that the door is completely closed.

Meanwhile, it is preferred that at least an sidewall of the roaster box is composed of an inner box and an outer box, spaced apart from each other, and the air supply means supplies air into a space formed between the outer box and the inner box.

In addition, an air supply tube is preferably installed in the space formed between the outer box and the inner box in connection with the air supply means, and a plurality of discharge holes are preferably formed in the air supply tube so as to discharge the air supplied from the air supply means into the space formed between the outer box and the inner box.

At this time, it is possible that a plurality of additional discharge holes are formed in the air supply tube toward the heat generation device, and a communication hole is formed in the inner box at a position corresponding to the additional discharge holes so that the air discharged from the additional discharge holes is supplied to the heat generation device.

In addition, it is preferred that the air supply tube discharges air upward in the space between the inner box and the outer box, and at least two rows of holes are formed in the outer box in which one row of holes are formed at positions near the air discharge holes of the air supply tube and other row of holes are formed above one row of holes so that the air discharged from the air supply tube promotes flow of air that is introduced through one row of holes and discharged out through other row of holes.

Preferably, the heat generation device includes a burner for combusting gas to generate heat, and a charcoal ignited by the burner, and the roaster further comprises a gas supply unit for supplying gas to the charcoal arranged on the heat generation device.

Meanwhile, the roaster may further include a second sensor for sensing a state that the door is completely opened, wherein the gas supply unit supplies gas only when the second sensor senses that the door is completely opened.

In addition, a heat guide plate inclined inwardly is preferably installed in the roaster box at a position spaced upward from the heat generation device by a predetermined distance, and it is also preferred that one end of the heat guide plate is inserted into the roaster box to be capable of being inserted in and drawn out from the roaster box so that the heat guide plate is not deformed due to expansion by heat, and a hook is formed on the other end of the heat guide plate so that the heat guide plate is coupled to the roaster box without unintended separation.

Meanwhile, the roaster box may be installed to a table, and the door may be inserted below an upper plate of the table when being opened.

In another aspect of the invention, the heat generation device includes a pipe burner for combusting gas to give flames, a charcoal support having a charcoal placing region on which charcoal is placed is detachably installed on the pipe burner, and the roaster includes an air supply unit for supplying air in a lateral direction toward the charcoal placed on the charcoal support from a position laterally spaced apart from the charcoal support.

Preferably, at least two rows of gas holes are formed in an upper portion of the pipe burner at positions spaced apart from each other in right and left directions based on a vertical centerline of the pipe burner, and gas is injected in an inclined upper direction through the gas holes.

In addition, the charcoal support may include seating portions seated on both ends of circumference of the pipe burner; and a charcoal placing portion installed on the seating portions and positioned above the pipe burner when being installed to the pipe burner, the charcoal placing portion providing a charcoal placing region on which charcoal is placed, wherein extensions are extended downward from both ends of the charcoal placing portion so that a width between the extensions gets wider downward, wherein the extensions cover the gas holes of the pipe burner at positions spaced upward from the gas holes by a predetermined distance.

Preferably, the charcoal support further includes barriers extended upward from right and left ends of the seating portions to prevent the charcoal placed on the charcoal placing portion from deviating unintentionally, and an airflow hole is formed in the barriers so that the air supplied from the air supply unit is oriented to the charcoal placed on the charcoal placing portion.

At this time, the air supply unit may include an air supply tube installed at a position laterally spaced apart from the charcoal support by a predetermined distance;

and a blower for supplying air to the air supply tube, wherein a plurality of air discharge holes are formed in the air supply tube toward the charcoal support.

Preferably, at least a sidewall of the roaster box is composed of an inner box and an outer box, spaced apart from each other, and the air supply tube is installed in a space formed between the inner box and the outer box at a position laterally spaced apart from the charcoal support by a predetermined distance.

Preferably, a plurality of air discharge holes are formed in the air supply tube toward the charcoal support, and an airflow hole is formed in the inner box at a position corresponding to the air discharge holes so that the air discharged from the air discharge holes is supplied to the charcoal support.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a perspective view showing a front side of a roaster according to the present invention;

FIG. 2 is a perspective view showing a rear side of the roaster according to the present invention;

FIG. 3 is an exploded perspective view showing a door mounted to the roaster according to the present invention;

FIG. 4 is a partially sectioned perspective view showing inner configuration of the roaster according to the present invention;

FIG. 5 is a sectional view showing a heat generation device installed in the roaster according to the present invention;

FIG. 6 is a sectional view showing inner configuration of the roaster according to the present invention;

FIG. 7 is a perspective view showing a heat guide plate installed in the roaster according to the present invention;

FIG. 8 is a perspective view showing that an oil receiver is separated from the roaster according to the present invention;

FIG. 9 is a perspective view showing a gas exhausting hole formed in the roaster according to the present invention;

FIG. 10 is a perspective view showing that the roaster according to the present invention is installed in a table;

FIG. 11 is a perspective view showing a roaster equipped with a charcoal ignition device according to the present invention;

FIG. 12 is a partially sectioned perspective view showing inner configuration of the roaster of FIG. 11;

FIG. 13 is a perspective view showing the charcoal ignition device installed to the roaster of FIG. 11;

FIG. 14 is a sectional view showing a charcoal container of the charcoal ignition device shown in FIG. 13;

FIG. 15 is an exploded perspective view showing the charcoal container of FIG. 14; and

FIG. 16 is a sectional view illustrating that the charcoal ignition device ignites charcoal.

### BEST MODE FOR CARRYING OUT THE INVENTION

Hereinafter, the preferred embodiments of the present invention will be described in detail with reference to the accompanying drawings. The terms used should not be construed as limited to general and dictionary meanings but based on the meanings and concepts of the invention on the basis of the principle that the inventor is allowed to appropriate define terms for the best explanation. Therefore, the description herein the scope of the invention be understood that other and modifications could be made thereto without departing from the spirit and scope of the invention.

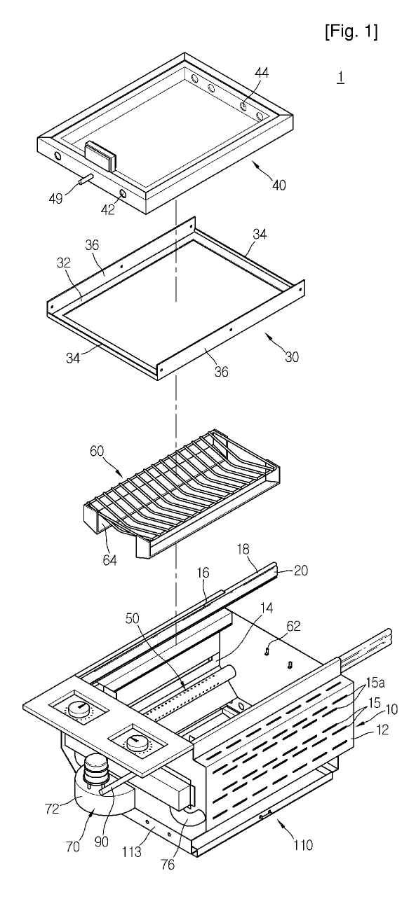

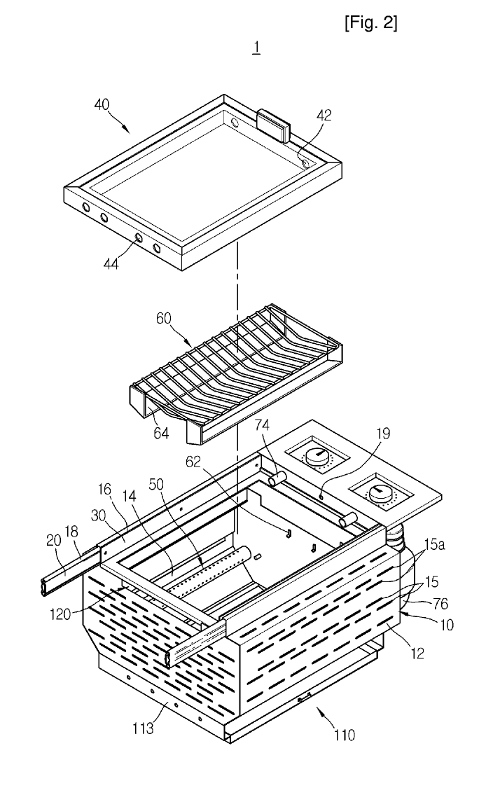

FIGS. 1 and 2 are perspective views showing front and rear sides of a roaster according to one embodiment of the present invention, respectively. Referring to FIGS. 1 and 2, the roaster 1 of the present invention includes a roaster box 10 that configures an overall appearance of the roaster 1. The roaster box 10 has a hexahedral shape, and has an upper portion open. On the open upper portion of the roaster box 10, a door 40 is horizontally installed to be capable of opening and closing.

In the roaster box 10, installed are a heat generation device 50 and a meat fixing means 60. The heat generation device 50 is used for supplying heat to meat, and all kinds of devices capable of generating heat, such as gas burner or charcoal, may be used. Preferably, the heat generation device 50 may use a gas burner and charcoal together.

In addition, the meat fixing means 60 is used for fixing meat to be cooked by heat generated from the heat generation device 50, and preferably a grill is used as the meat fixing means 60. The meat fixing means 60 may be detachably mounted to the roaster box 10, and a mount 62 is formed on an inner side of the roaster box 10 so as to mount the meat fixing means 60. In addition, though installation positions of the heat generation device 50 and the meat fixing means 60 are not specially defined in the present invention, a pair of heat generation devices 50 are preferably mounted to horizontally space apart from each other in the roaster box 10, and the meat fixing means 60 is installed above the heat generation devices 50 at a region between the heat generation devices 50.

Preferably, guide members 64 are attached to both ends of the meat fixing means 60 as shown in FIG. 1 so as to partially intercept radiant heat of the heat generation devices 50 and guide flow of combustion gas. The guide member 64s are installed at positions spaced apart from both ends of the meat fixing means 60 by a predetermined distance, and preferably the guide members 64 are installed with a slope so that an outer portion is higher and an inner portion is lower. The guide member 64 has front and rear ends bent upward and attached to the meat fixing means 60, so a lateral space is formed between the guide member 64 and the meat fixing means 60 so as not to disturb heat transfer by convection. Such guide members 64 partially intercept radiant heat of the heat generation device 50, preventing the radiant heat of the heat generation devices 50 from being directly transferred to both ends of the meat fixing means 60, which are nearest to the heat generation devices 50. If radiant heat of the heat generation device 50 is directly supplied to the meat fixing means 60, meat placed on the meat fixing means 60 becomes cooked in different extents depending on position, so any meat placed at a position near the heat generation device 50 becomes overdone or burned. Thus, the guide member 64 makes the radiant heat of the heat generation device 50 not be directly radiated to the meat fixing means 60 so that meat placed on the meat fixing means 60 is not burned or cooked too fast by means of the radiant heat. Meanwhile, since heat transfer by convection is ensured through the space between the guide member 64 and the meat fixing means 60, all meat placed on the meat fixing means 60 becomes cooked regularly as a whole.

A pair of guides 16 are installed in an upper portion of the roaster box 10. The guides 16 have a structure ensuring stable installation of a carrying means described later. The guide 16 preferably has a ‘c’ shape whose section is open inwards so that the carrying means described later is inserted into the groove. In addition, the guide 16 is firmly fixed to the upper portion of the roaster box 10 by means of screwing or the like. At this time, the guides 16 preferably have extensions 18 extended rearward (in a direction that the door is opened) by a predetermined length at upper ends of both sides of the roaster box 10. The role of the extensions 18 will be explained later.

The carrying means is installed to the guides 16 to be capable of moving in a horizontal direction. The carrying means generally calls all components that are carried by the guides 16 and support the door 40, and it is composed of a slider 20 and a door support 30, in brief.

The slider 20 is mounted to the pair of guides 16 to be capable of horizontally sliding. The slider 20 may employ any slider using lubricant and/or rolling bearings, and any slider that may slide horizontally by means of the guides 16 may be used.

The door support 30 is coupled to the pair of sliders 20 and moves in a horizontal direction together with the sliders 20. The door support 30 includes a seating portion 32 on which each end of the door 40 is seated, and a door restricting portion 34 for restricting the door 40 seated on the seating portion 32 so that the door 40 is not deviated in forward or rearward direction.

The seating portion 32 is formed using a substantially rectangular plate, and has a width sufficient for supporting the ends of the door 40 but not unnecessarily great. That is to say, the seating portion 32 1 formed not to excessively hide a lower portion of the door 40 when the door 40 is seated thereon.

The door restricting portion 34 is vertically protruded up at front and rear ends of the seating portion 32 by a predetermined height. The door restricting portion 34 may be formed over the entire region of the front and rear ends of the seating portion 32 as shown in the figures, but it may also be formed in a partial region of the front and rear ends. Such a door restricting portion 34 prevents the door 40 from deviating forward or rearward when the door 40 is opened or closed.

Meanwhile, coupling portions 36 for coupling with the slider 20 are extended vertically at right and left ends of the seating portion 32. Thus, the door support 30 restricts the door 40 seated thereon substantially in all of right, left, front and rear directions.

As mentioned above, the door 40 is used with being seated on the door support 30, and there is no need of separate combination. Thus, in case that a user lifts the door 40 up, the door 40 may be easily separated from the door support 30. Of course, it is also possible that the door 40 is combined to the door support 30 by means of a separate combination means.

Meanwhile, the guide 16 has the extension 18 extended a predetermined length from the roaster box 10 in a direction that the door 40 is opened, as mentioned above. When the door 40 is completely opened, the door 40 is slightly laid at the rear end of the roaster box 10 or moves beyond the rear end so that the inner space of the roaster box 10 may be exposed completely. At this time, the extension 18 supports the door support 30 that moves together with the door 40, and thus the door 40 keeps a horizontal state by support of the guide 16 even in a completely opened state.

In this embodiment, the door 40 has a predetermined inner space which air is introduced in and discharged out. The door 40 is formed on the upper portion of the roaster box 10 and is apt to be exposed directly to heat, so it may deteriorate cooking environments and cause accidents such as burn by overheating. Thus, if the inner space is formed in the door 40, heat in the roaster box 10 is not transferred to outside due to adiabatic effects of the inner space. In particular, since air may be introduced in and discharged out of the inner space of the door 40, fresh external air is introduced therein to promote the cooling effects.

More preferably, the roaster 1 of the present invention is provided with an air supply means 70 for supplying air to the inner space of the door 40. The air supply means 70 may employ all kinds of devices that may supply air forcibly by using a fan or the like. If such an air supply means 70 introduces air into the inner space of the door 40, air is exchanged in the inner space of the door 40, thereby maximizing adiabatic effects and cooling effects.

The air supply means 70 includes a blower 72 fixed to the roaster box 10 to generate airflow by means of an external power source, and an air supply path 74 for transferring the air generated in the blower 72 toward the door 40.

The blower 72 is a device for forcibly generating airflow by means of a fan or the like, and all kind of known devices that generate a suitable level of airflow may be employed. In addition, the air supply path 74 transfers the air generated by the blower 72 toward the door by using a pipe or the like, and its structure is not specifically limited. Moreover, in order to generate air flow, the blower 72 may inhale external air or an air in the roaster box 10.

However, as an example, the air supply path 74 may be configured to protrude toward the inner space at the upper portion of the roaster box 10 by a predetermined length, and a communication hole 42 may be formed in the door 40 at a corresponding position so that the air supply path 74 communicates with the communication hole 42 when the door 40 is completely closed. In this configuration, the door 40 may receive the air from the blower 72 and play its own adiabatic and cooling function only when it is completely closed. In fact, the adiabatic and cooling functions of the door 40 are mainly needed when the door 40 is closed, so such configuration may effectively eliminate unnecessary pipe connections.

Meanwhile, the communication hole 42 is formed at a front portion of the door 40 that is contacted with the roaster box 10 when the door 40 is closed. To the contrary, a discharge hole 44 for discharging air from the inner space of the door 40 to outside is formed at a position opposite to the communication hole 42, namely in a rear potion of the door 40. Thus, the air supplied from the air supply means 70 is supplied into the inner space of the door 40 through the communication hole 42 and then discharged out through the discharge hole 44. That is to say, in the inner space of the door 40, airflow is directed from the front portion of the door 40 to the rear portion.

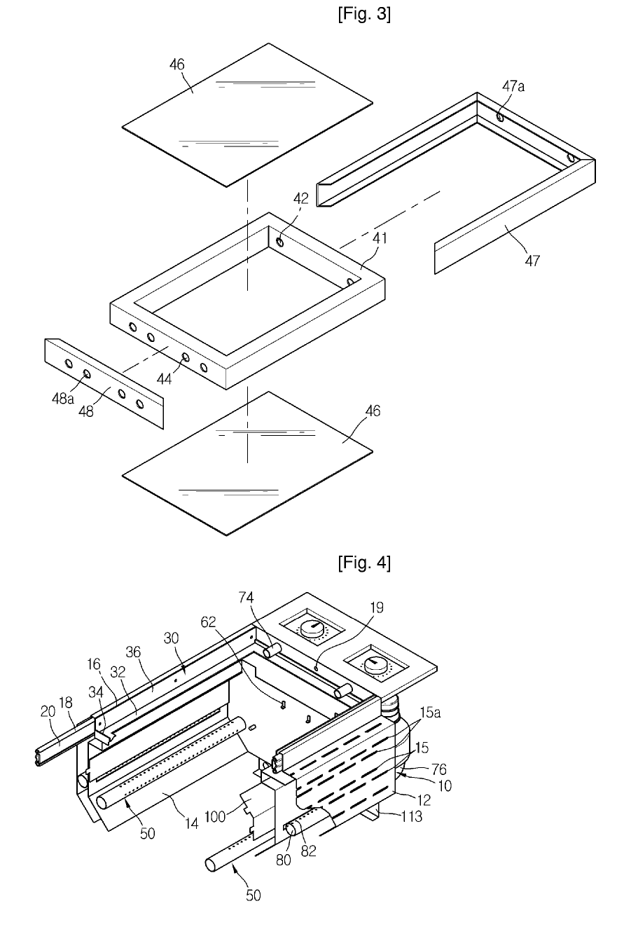

Such configuration of the door 40 is shown in FIG. 3 in more detail. Referring to FIG. 3, the door 40 has a quadrangular frame 41 in which the communication hole 42 and the discharge hole 44 are formed. The quadrangular frame 41 has an airflow space therein for air to flow through it, and the communication hole 42 is formed in the front side of the quadrangular frame 41 and the discharge hole 44 is formed in the rear side of the quadrangular frame 41. In addition, though it is shown in the figures that two communication holes 42 and four discharge holes 44 are formed in the quadrangular frame 41, the number of communication holes 42 and discharge holes 44 may be selected as desired. However, the position and number of the communication holes 42 should be selected in accordance with the air supply path 74. In addition, the sides of the quadrangular frame 41 are parallel to the slider 20.

Glasses 46 are adhered to upper and lower surfaces of the aforementioned quadrangular frame 41 respectively. The glasses 46 allow users to recognize the inside of the roaster box 10 from outside though the door 40 is closed.

With the glasses 46 being adhered, the quadrangular frame 41 and the glasses 46 are firmly coupled by means of fixing frames 47 and 48. At this time, a hole 47a corresponding to the communication hole 42 is formed in the fixing frame 47 contacted with the front side of the rectangular frame 41, which a hole 48a corresponding to the discharge hole 44 is formed in the fixing frame 48 contacted with the rear side of the rectangular frame 41.

The door 40 configured as above forms a space between the rectangular frame 41 and the upper and lower glasses 46. Thus, as for the airflow in the door 40, air is introduced into the inner space of the door 40 through the communication hole 42 of the rectangular frame 41 and then discharged out through the discharge hole 44. In addition, since the airflow space is also formed in the rectangular frame 41 itself, the air introduced through the communication hole 42 is also flowed through the rectangular frame 41 and discharged out through the discharge hole 44.

Meanwhile, the roaster of the present invention may be provided with sensors 19 and 49 for sensing a completely closed state of the door 40. These sensors 19 and 49 are installed at positions of the roaster box 10 and the door 40 that are contacted when the door 40 is completely closed, so as to sense a completely closed state of the door 40. The sensors may employ touch switch, limiter switch, approach sensor and so on, not limitedly.

At this time, the air supply means 70 may control operation of the blower 72 according to a sensing result of the sensor. That is to say, if the sensor senses that the door 40 is completely closed, the blower 72 is operated to supply air to the door 40, while, if not, the blower 72 is not operated so that air is not supplied. In this case, a user may control operation of the air supply means 70 just by opening or closing the door 40 without manipulating the air supply means 70 in any separate way.

In this embodiment, the aforementioned airflow may be provided to sides of the roaster box 10 as well as the door 40. For this purpose, at least a sidewall of the roaster 10 is composed of an outer box 12 and an inner box 14 between which an empty space is formed. The space between the outer box 1 and the inner box 14 gives an adiabatic effects by itself since it prevents heat generated in the roaster box 10 from being radiated outward. In this embodiment, air is forcibly blown into the space between the outer box 12 and the inner box 14 so as to maximize the sidewall adiabatic and cooling effects of the roaster box 10.

That is to say, the air supply means 70 is provided with an additional air supply path 76 for supplying the air generated in the blower 72 to the space between the outer box 12 and the inner box 14. The air supplied through the air supply path 76 is transferred to the space between the outer box 12 and the inner box 14 to promote airflow in the space between the outer box 12 and the inner box 14, and then discharged out through a plurality of holes 15a formed in the outer box 12.

At this time, in this embodiment, an air supply tube 80 may be installed in the space between the outer box 12 and the inner box 14 so as to maximize airflow in the space between the outer box 12 and the inner box 14 as shown in FIG. 4. Referring to FIG. 4, the air supply tube 80 is installed at a height substantially identical to the heat generation device 50 in the space between the outer box 12 and the inner box 14, and a plurality of discharge holes 82 are formed in an upper portion of the air supply tube 80. In addition, the air supply tube 80 is connected to the blower 72 via the air supply path 76 so as to discharge the air supplied from the blower 72 into the space between the outer box 12 and the inner box 14 through the discharge holes 82.

Heat generated in the heat generation device 50 is generally oriented upward by means of convection, and the sidewalls of the roaster box 10 is more affected by the heat in its upper portion than in its lower portion. Thus, the discharge holes 82 are preferably formed in the upper portion of the air supply tube 80 so as to give adiabatic and cooling effects mainly to the upper portion of the sidewall of the roaster box 10.

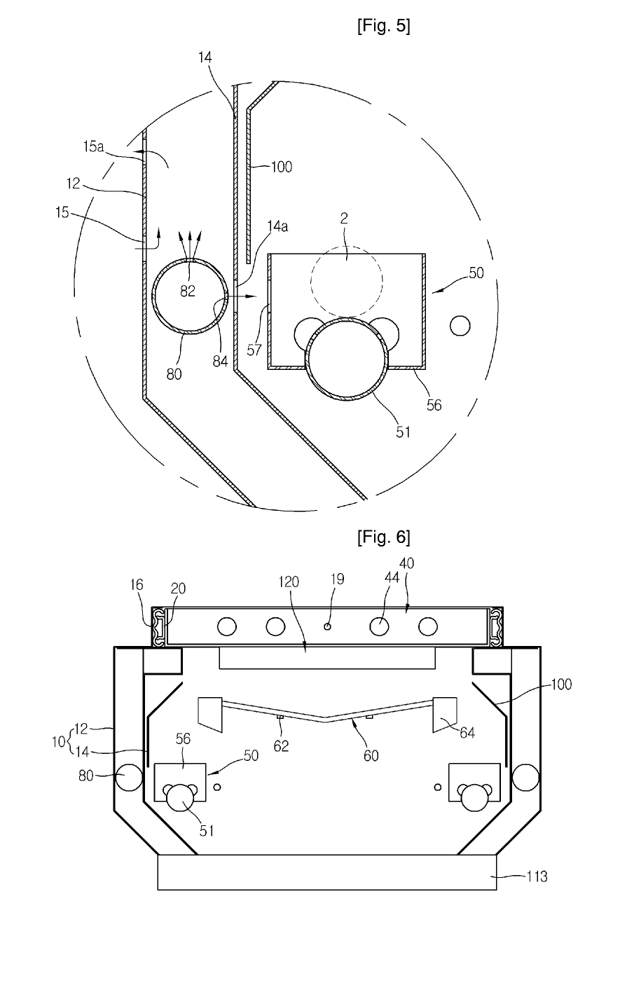

At this time, the air supply tube 80 may be provided with additional discharge holes 84 in addition to the aforementioned discharge holes 82. The additional discharge holes 84 are particularly effective when the heat generation device 50 uses charcoal 2. Charcoal 2 may be supplied into the roaster box 10 after being fired, and it is also possible that an unfired charcoal is positioned and then ignited by using a burner or the like. Referring to FIG. 5, charcoal 2 is arranged above the heat generation device 50 in the roaster box 10, and the air supply tube 80 is installed at a height substantially identical to the charcoal 2. At this time, the additional discharge holes 84 are formed in an inward side of the air supply tube 80. In addition, a communication hole 14a is formed in the inner box 14 at a position corresponding to the additional discharge holes 84. Thus, the air discharged through the additional discharge holes 84 of the air supply tube 80 is supplied to the charcoal 2 through the communication hole 14a. The air supplied to the charcoal 2 gives oxygen to the charcoal 2, playing a role of enhancing heating power of the charcoal. Of course, in case that a charcoal fixing unit 56 is installed to fix the charcoal 2 and this charcoal fixing unit 56 blocks flow of the air discharged through the discharge holes 84, a communication hole 57 is also formed in the charcoal fixing unit 56 at a position corresponding to the discharge holes 84 as shown in FIG. 5. Such configuration will be described later in more detail using another embodiment.

Meanwhile, referring to FIG. 5 again, the holes 15 and 15a formed in the outer box 12 are used for natural convection between air in the space between the outer box 12 and the inner box 14 and external air. Such holes 15 and 15a may give better air circulation effects depending on their positions when air is ejected through the discharge holes 82 of the air supply tube 80. For example, the holes 15 and 15a are formed in two rows in this embodiment, wherein a first row of holes 15 positioned lower is formed near the discharge holes 82 of the air supply tube 80 and a second row of holes 15a are formed above the discharge holes 82. At this time, the air ejected through the discharge holes 82 is spread out upward within an angle based on the discharge holes 82, so the first row of holes 15 is not directly contacted with the air ejected through the discharge holes 82. However, since the air ejected through the discharge holes 82 lowers pressure around the holes 15, external air is more vigorously introduced through the holes 15. In addition, since the second row of holes 15a are positioned above the discharge holes 82, the holes 15a are not directly affected by the air ejected through the discharge holes 82. Thus, the air introduced through the first row of holes 15 ascend faster due to the air ejected through the discharge holes 82, and then ejected out rapidly through the second row of holes 15a. Such structure of the holes 15 and 15a promotes airflow in the space between the outer box 12 and the inner box 14, resulting in further enhancing the cooling and adiabatic effects of the sidewalls of the roaster box 10.

Referring to FIG. 5 again, the heat generation device 50 employed in the roaster 1 of the present invention may use a charcoal 2 and a burner 51 for generating heat by combustion of gas and igniting the charcoal 2. In this case, the burner is used only for igniting the charcoal 2, and it is not used any more once the charcoal 2 is ignited. In the step of igniting the charcoal 2, it is safe that a user directly checks an ignited state of the charcoal 2 by the naked eyes, so the igniting process is preferably conducted with the door 40 opened. If the burner is used with the door 40 closed or partially opened, there arises any accident due to overheat of the door 40. In particular, in case that the air supply means 70 is designed to operate with the door 40 opened, the air supplied to the charcoal 2 may even disturb ignition of the charcoal 2.

Thus, this embodiment may be configured so that the burner is operated only when the door 40 is completely opened. For this purpose, a sensor (not shown) for sensing a completely opened state of the door 40 may be additionally installed to the roaster box 10. This sensor is installed at a position of the upper portion of the roaster box 10, which is directly contacted with a certain portion of the door 40 when the door is completely opened so as to sense a completely opened state of the door 40. The sensor may use a touch switch, a limiter switch, an approach sensor and so on, not limitedly.

At this time, a gas supply unit 90 is mounted to the roaster box 10 so as to supply gas to the burner. The gas supply unit 90 is controlled to supply gas to the burner for igniting the charcoal 2 only when the sensor senses the completely opened state of the door 40, and to intercept supply of gas when the door 40 is not completely opened, thereby being capable of prevent any accident such as burn in advance.

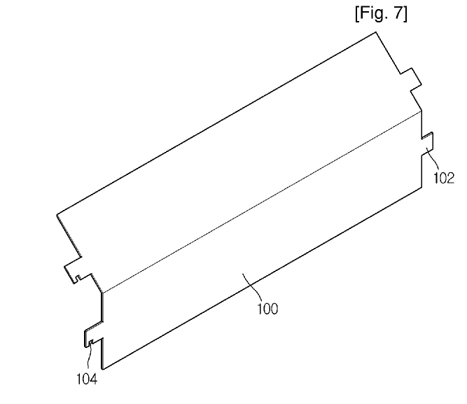

Referring to FIGS. 6 and 7, a heat guide plate 100 is mounted in the roaster box 10. The heat guide plate 100 is mounted to front and rear sides in the roaster box 10 at positions spaced apart from each other above the heat generation device 50, and its upper portion is inclined inwardly. Thus, the heat guide plate 100 guides the heat generated from the heat generation device 50 to be naturally oriented to the meat fixing means 60.

Such a heat guide plate 100 is directly exposed to the heat of the heat generation device 50, so it is apt to be expanded due to heat. If the heat guide plate 100 is expanded by means of heat as mentioned above, the heat guide plate 100 may be bent or deformed in case that both ends of the heat guide plate 100 are fitted into the roaster box 100. Thus, in this embodiment, the heat guide plate 100 has a length slightly smaller than the inner space of the roaster box 10, and an insert 102 is formed at one end of the heat guide plate 100 so that the insert 102 may be inserted into and drawn out from the roaster box 10. That is to say, though the heat guide plate 100 is expanded due to heat, its overall shape is not deformed but keeps its original shape with its one end being inserted into the roaster box 10. The other end of the heat guide plate 100 has a hook 104 so as not to be departed from the roaster box 10.

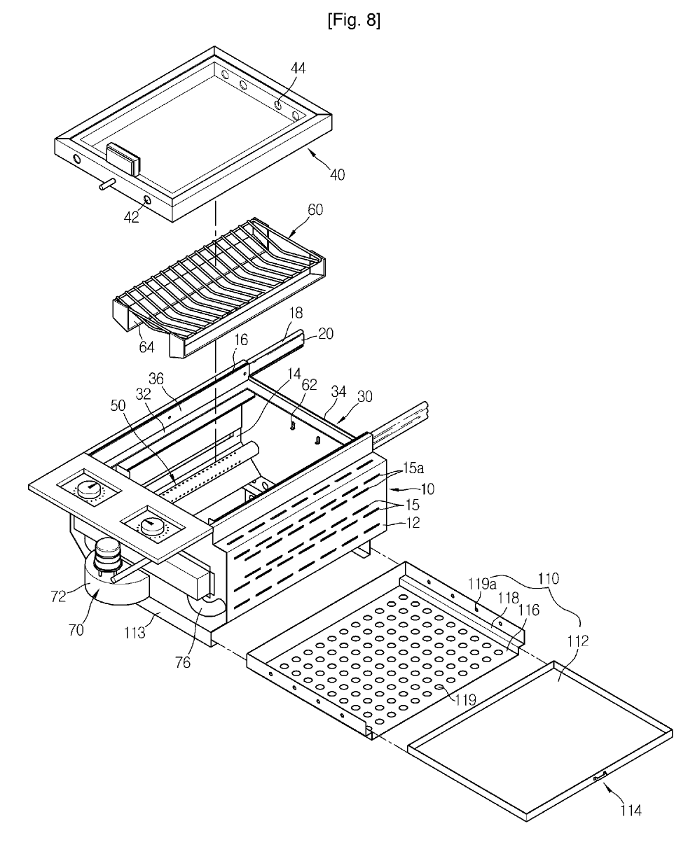

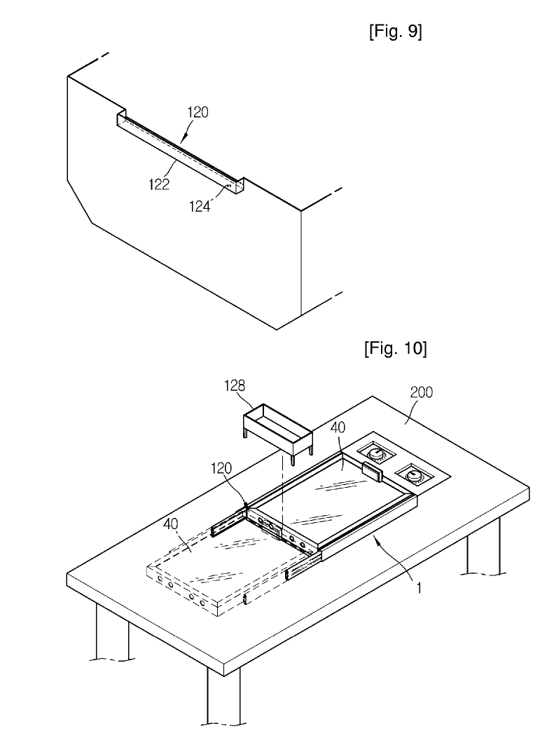

Meanwhile, the roaster 1 of the present invention may include a dirt collector 110 at a lower portion of the roaster box 10 so as to collect and remove dirt generated in the cooking procedure. Referring to FIG. 8 together with FIG. 1, the dirt collector 110 includes a heatproof plate 116 attached to a lower portion of the roaster box 10 and a dirt collecting case 112 detachably inserted into the heatproof plate 116. The heatproof plate 116 has projections 118 at its sides so that the projections 118 are seated on bent portions 113 formed on the lower portion of the roaster box 10. In this state, the heatproof plate 116 is fixed to the roaster box 10 by using coupling holes 119a. At this time, a plurality of holes 119 are formed in the lower portion of the heatproof plate 116 to facilitate air ventilation with external air. In addition, the dirt collecting case 112 is inserted to seat on the bottom surface of the heatproof plate 116 in which the holes 119 are formed. At this time, a handle 114 is formed on the dirt collecting case 112 so that the dirt collecting case 112 may be easily inserted or drawn out.

Meanwhile, a gas exhaust hole 120 may be formed in a rear upper portion of the roaster box 10 so as to exhaust combustion gas generated in the roaster box 10. The gas exhaust hole 120 is formed in the upper portion of the roaster box 10, more specifically just below the door 40, to play a role of naturally exhausting combustion gas in the roaster box 10 to outside. At this time, in order to guide the combustion gas upward through the gas exhaust hole 120, a combustion gas guide 122 may be mounted to a rear portion of the roaster box 10 to surround the gas exhaust hole 120. The combustion gas guide 122 surrounds the entire gas exhaust hole 120, but a lower end of the combustion gas guide 122 is formed below the gas exhaust hole 120. Thus, the upper surface of the roaster box 10 formed by the gas exhaust hole 120 in the combustion gas guide 122 is placed higher than the bottom of the combustion gas guide 122, and resultantly impurities stacked in the combustion gas guide 122 are not flowed into the roaster box 10. In addition, a hole 124 is formed in the bottom of the combustion gas guide 122 so that impurities such as water introduced into the combustion gas guide 122 may be naturally flowed out.

In addition to that, in the roaster box 10, there may be additionally installed a temperature sensor for sensing inner temperature of the roaster box 10, a light for lighting the inner space of the roaster box 10 and so on.

Meanwhile, the roaster of the present invention, configured as above, may be used independently or in combination with a table. In case that the roaster is attached to a table, as shown in FIG. 10, a hole having a shape corresponding to the roaster is perforated in the table 200, and the roaster 1 of the present invention is installed in the perforated hole. At this time, since the door 40 is horizontally moved for opening and closing the roaster of the present invention, there needs a space for the door 40 to move. The door 40 may move above the table in contact with the upper surface of the table, but preferably the door 40 is inserted below an upper plate of the table. In FIG. 10, a state that the door 200 is opened and inserted below the upper plate of the table 200 is shown as a dotted line.

In addition, in case that the door 40 is completely opened, the door 40 is moved out of the roaster box 10 by means of the extensions 18, and the gas exhaust hole 120 exhausts combustion gas through a space between the roaster box 10 and the door 40. At this time, since the combustion gas exhausted from the gas exhaust hole 120 is heated to a certain temperature, a dish 128 may be placed on the table 200 above the gas exhaust hole 120 so that cooked meat may be placed on the dish 128.

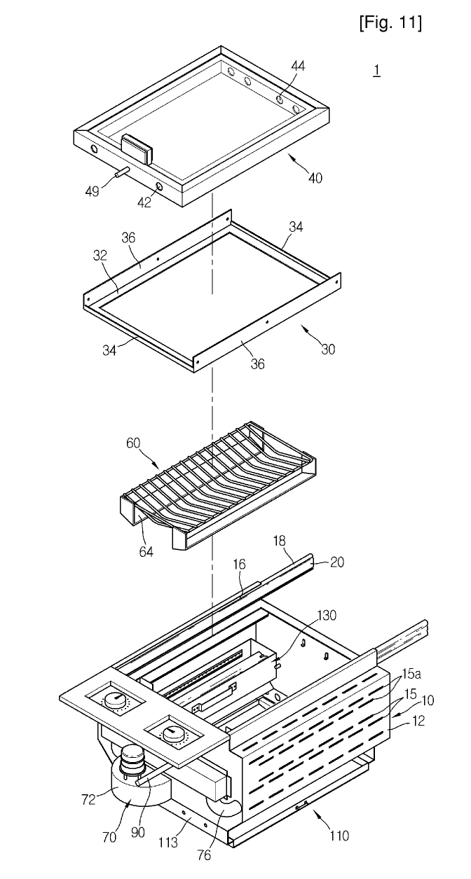

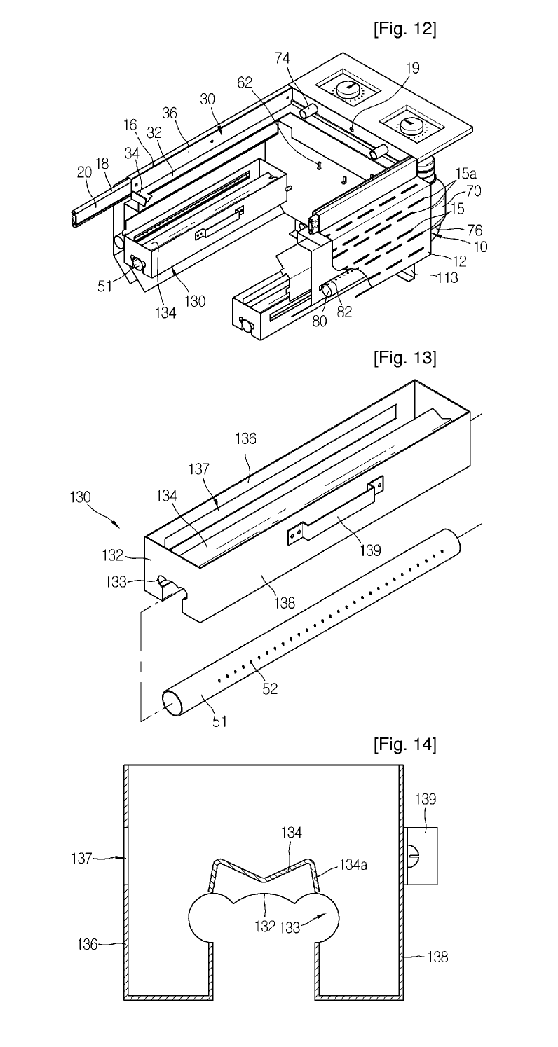

FIG. 11 is a perspective view showing a roaster 1 according to another embodiment of the present invention, and FIG. 12 is a partially sectioned perspective view showing inner configuration of the roaster 1 of this embodiment. In the figures, the same components having the same function as that of the former embodiment are indicated by the same reference numeral, and they are not described in detail here.

Referring to FIGS. 11 and 12, the sidewalls of the roaster box 10 that configure the overall appearance of the roaster 1 of this embodiment are configured in a dual structure composed of the outer box 12 and the inner box 14, and a predetermined space is formed between the outer box 12 and the inner box 14.

In this embodiment, a pipe burner 51 and charcoal 2 are used together as a heat generation device, and the pipe burner 51 and a charcoal support 130 are installed in the roaster box 10. The pipe burner 51 combusts gas to give flame, and another kind of flame generation device having the same function as the pipe burner may also be used. The pipe burner 51 is fixed to front and rear side in the roaster box 10, and a plurality of gas holes 52 are formed in the upper portion of the pipe burner 51. The gas holes 52 are formed in at least two rows spaced apart from each other in right and left directions based on a vertical centerline at the upper portion of the pipe burner 51 (see FIG. 16). At this time, the gas supply unit 90 is installed to the roaster box 10 to supply gas to the pipe burner 20.

The charcoal support 130 is detachably mounted above the pipe burner 51, and a charcoal placing region is provided to its upper portion so as to place charcoal thereon. The charcoal support 130 has a length substantially identical to or slightly smaller than the pipe burner 51, and is fixed to the roaster box 10 with being seated on the pipe burner 51.

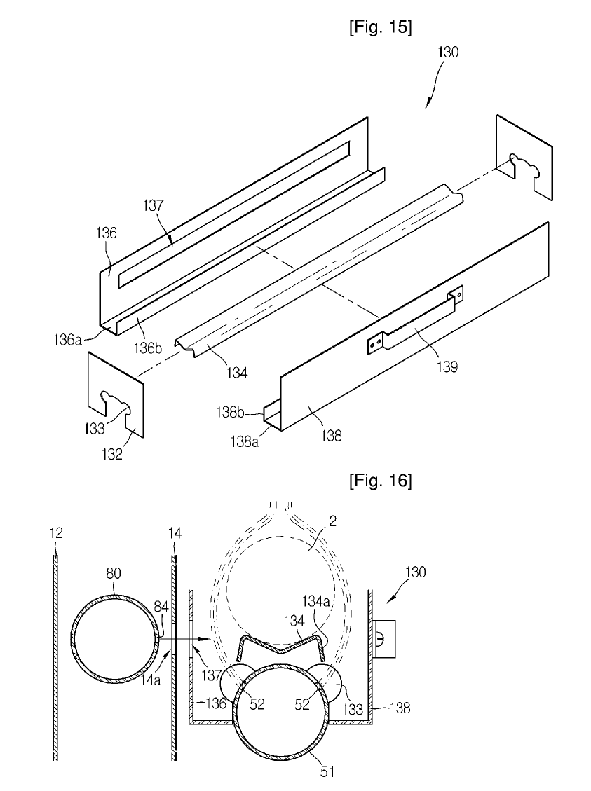

Referring to FIGS. 13 to 15, the charcoal support 130 includes seating portions 132 at both ends thereof, which are seated on circumferences of both ends of the pipe burner 51. The seating portion 132 has a groove corresponding to the shape of the pipe burner 51, and it is substantially line-contacted with the circumference of the pipe burner 51. At this time, a recess 133 is formed in the seating portion 132 at a region that is contacted with the gas holes 52 so that the seating portion 132 may not intercept the gas holes 52 of the pipe burner 51. In fact, when the pipe burner 51 is ignited, flames are made subsequently in a length direction through the plurality of gas holes 52. Thus, the recess 133 is purposed not to disturb the subsequent ignition of flames when the pipe burner 51 is ignited.

A charcoal placing portion 134 is installed to the seating portion 132. The charcoal placing portion 134 substantially connects the seating portions 132 at both ends of the pipe burner 51, and it is arranged at a position slightly spaced apart from the pipe burner 51 upwardly when the seating portion 132 is seated on the pipe burner 51. The charcoal placing portion 134 has a V-shaped groove in its upper portion to give a charcoal placing region on which charcoal is placed. The V-shaped groove prevents the charcoal placed thereon from rolling or falling down. In addition, the charcoal placing portion 134 has extensions 134a extended downward with a slope at its both sides. The extensions 134a get wider downward and are extended to a predetermined distance out of the gas holes 52 of the pipe burner 51. Such extensions 134a covers the gas holes 52 of the pipe burner 51 so as to prevent impurities such as ashes from introducing into the gas holes 52. Of course, since the extensions 134a are positioned at positions spaced a predetermined distance from the gas holes 52 upward, they do not intercept gas injected in a sloped upper direction from the gas holes 52.

Thus, in the charcoal support 130, a gas flow path is formed at a position where the gas holes 52 of the pipe burner 51 are arranged, so that the gas supplied from the gas holes 52 may move to the charcoal placed on the charcoal placing portion 134. This gas flow path makes the gas holes 52 exposed to the charcoal when the seating portions 132 seat on the pipe burner 51.

At this time, the charcoal support 130 may further include barriers 136 and 138 that bar both sides of the charcoal so as to keep the charcoal placed on the charcoal placing portion 134 in a more stable way. The barriers 136 and 138 are coupled to the seating portions 132, and connect the seating portions 132 provided to both ends of the charcoal support 130, similarly to the charcoal placing portion 134.

The barriers 136 and 136 form both sidewalls of the charcoal support 130 and are extended higher than the charcoal placing portion 134 by a predetermined length. Thus, the barriers 136 and 138 prevent the charcoal placed on the charcoal placing portion 134 from deviating out of the charcoal support 130.

The barriers 136 and 138 respectively have horizontal portions 136a and 138a extended inward by a predetermined length and bent portions 136b and 138b bent from the inner ends of the horizontal portions 136a and 138a upward, at their lower ends. The bent portions 136b and 138b come in contact with the side of the pipe burner 51 when the charcoal support 130 is seated on the pipe burner 51, which ensures more stable combination structure between the charcoal support 130 and the pipe burner 51.

At this time, an airflow hole 137 is formed in the barrier 136 near the sidewall of the roaster box 10 among the aforementioned barriers. The airflow hole allows the air supplied from an air supply unit, described later, to flow toward the charcoal placed on the charcoal placing portion 134.

In addition, a handle 139 may be mounted to the other barrier 138 near the inside of the roaster box 10 so that a user may grip it. Shape and installation manner of the handle 139 may be realized in various ways, not limitedly.

The roaster 1 of the present invention includes an air supply unit to supply air to the charcoal placed on the aforementioned charcoal support 130. The air supply unit may employ any kind of device that may form certain airflow toward the charcoal placed on the charcoal support 130. In this embodiment, an air supply tube 80 is used as the air supply unit.

The air supply tube 80 is installed at a position laterally spaced apart from the charcoal support 130 by a predetermined distance and supplies air toward the charcoal 2 placed on the charcoal support 130 (see FIG. 16). For this purpose, a plurality of air discharge holes 82 are formed in the air supply tube 80 toward the charcoal support 130. Lateral airflow provided from the air supply tube 80 toward the charcoal support 130 continuously gives oxygen to the charcoal 2, thereby playing a role of enhancing heating power of the charcoal.

An installation position of the air supply tube 80 is selected to give lateral airflow to the charcoal support 130, and in this embodiment the air supply tube 80 is installed in the space between the outer box 12 and the inner box 14. At this time, since the inner box 14 is positioned between the air supply tube 80 and the charcoal support 130, a communication hole 14a is formed in the inner box 14 at a position corresponding to the air discharge holes 82 so that the air may flowed from the air discharge holes 82 to the charcoal 2. Thus, the air discharged from the air discharge holes 82 of the air supply tube 80 is oriented to the charcoal support 130 through the communication hole 14a of the inner box 14. At this time, since the airflow hole 137 is formed in the barrier 136 of the charcoal support 130, the air passes the airflow hole 137 and then flows toward the charcoal 2 placed on the charcoal placing portion 134.

In addition, a blower 70 is installed to the roaster box 10 so as to generate airflow to be supplied to the air supply tube 80, and the blower 70 and the air supply tube 80 are interconnected by means of an air supply path 76.

The roaster equipped with the charcoal ignition device according to this embodiment, configured as above, is operated as follows.

First, a user fixes the charcoal support 130 to a predetermined position in the roaster box 10, namely on the pipe burner 51. At this time, the charcoal support 130 is fixed to the front and rear inner walls of the roaster box 10, and the seating portions 132 of the charcoal support 130 are seated on the pipe burner 51. In addition, the gas holes 52 of the pipe burner 51 are exposed out through the space between the charcoal placing portion 134 and the barrier 136 and 138, namely through the space between the extension 134a and the vertical portion 136b, and the extension 134a is placed right above the gas holes 52 at a position upwardly spaced apart from the gas holes 52 by a predetermined distance.

After that, a user places unfired charcoal on the charcoal placing portion 134 of the charcoal support 130, and then supplies gas to the pipe burner 51 by means of a separate switch and at the same time ignites it.

The gas is supplied from the air supply unit 90 to the pipe burner 51, and at all gas holes 52, gas is subsequently ignited from a gas hole to which an ignition plug is provided. At this time, since the recess 133 is formed in the seating portion 132 of the charcoal support 130 at a region contacted with the gas holes 52, the seating portion 132 does not disturb subsequent ignition of gas though the ignition plug is arranged out of the charcoal support 130.

If gas is ignited, flames are formed between the charcoal placing portion 134 and the barriers 136 and 138 by means of the gas injected in an inclined upper direction through the space between the charcoal placing portion 134 and the barriers 136 and 138. These flames are joined together at their center with moving upwards, and accordingly the flames ignite the charcoal with surrounding the charcoal 2 placed on the charcoal placing portion 134.

At this time, together with or after ignition, a user manipulates a separate switch to inject air toward the charcoal 2. If the user manipulates the switch, the blower 70 is operated to supply air to the air supply tube 80, and this air is injected toward the charcoal 2, preferably to a lower portion of the charcoal 2, via the air discharge holes 82 of the air supply tube 80, the communication hole 14a of the inner box 14, and the airflow hole 137 in the barrier 136.

The air laterally injected toward the charcoal 2 gives oxygen to a fired region of the charcoal 2, promoting combustion of the charcoal 2 and giving better heating power. In particular, in case that a large charcoal is placed on the charcoal support 130, the air is supplied to a lower portion of the charcoal 2, and if the lower portion of the charcoal is completely combusted into ashes, the charcoal is collapsed due to its weight and then unfired region is exposed to the air injection area, so the charcoal may be combusted with high efficiency by means of the injected air. In addition, though a conventional charcoal roaster causes the generation of carbon monoxide due to incomplete combustion of charcoal, the charcoal ignition device of the present invention may completely combust carbon monoxide that may arise during the charcoal ignition process, since the flame and combustion gas formed by the pipe burner 51 surrounds the charcoal 2 and supplies hot combustion gas on a surface where smoldering is progressed. That is to say, since the charcoal ignition device of the present invention keeps a combustion temperature of the charcoal to a sufficient high level, smoldering is progressed but carbon monoxide is not generated.

In addition, since the extensions 134a of the charcoal placing portion 134 covers right above the gas holes 52 of the pipe burner 51 at a position spaced therefrom by a predetermined distance, impurities such as ashes and charcoal scraps generated while the charcoal 2 is combusted are not introduced into the gas holes 52, but flows down out of the pipe burner 51. Thus, though the pipe burner 51 is not used while the charcoal 2 is combusted, the gas holes 52 are not corked or polluted, allowing easier management of the pipe burner 51.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### INDUSTRIAL APPLICABILITY

The roaster of the present invention has an effect of increasing inner pressure of the roaster box by combustion gas and suppressing evaporation of gravy during the cooking procedure since the door is installed on the upper portion of the roaster box.

In addition, the roaster of the present invention ensures very stable movement of the door since the carrying means is installed to the roaster box in advance to be horizontally movable and then the door is placed on the upper portion of the carrying means. Moreover, since the door may be easily separated from the roaster box, it may be easily repaired, exchanged or cleaned.

Since the door of the roaster according to the present invention has a cooling function, heat of the fired charcoal generated during the cooking procedure is not transferred to users, so the users may not feel inconvenience or suffer from burns due to high temperature of the fired charcoal. Moreover, since oil adhered to the door is instantly cooled, it may be easily cleaned.

In addition, since the roaster of the present invention cools the sidewalls of the roaster box as well as the door, more agreeable circumstance is provided to users. Moreover, owing to forcible air circulation, the roaster box may be efficiently cooled without use of any adiabatic material.

In addition, since the heat guide plate for guiding hot air in the roaster box of the roaster according to the present invention has one end that may be inserted into or drawn out from the roaster box, the heat guide plate is not bent or deformed though it is expanded due to high temperature.

In addition, in case of the roaster equipped with the charcoal ignition device, since air is laterally supplied to charcoal when the charcoal is ignited using a pipe burner, it is possible to improve combustion efficiency of the charcoal and completely combust the charcoal.

In addition, since at least two rows of gas holes are formed in the pipe burner of the present invention to form flames surrounding the charcoal placed above the pipe burner, the charcoal is regularly combusted as a whole. Moreover, since the lateral air is oriented to the lower portion of the charcoal, if the lower portion of the charcoal is completely fired into ashes, other portions of the charcoal is moved to the air injection region due to its weight, so the placed charcoal may be completely combusted as a whole, thereby not generating carbon monoxide.

Thus, the roaster of the present invention may prevent the generation of harmful gas when the charcoal is fired, allow a user to select the meat fixing means such as a grill or a pan as desires, and enable to ignite charcoal by itself without damaging the smoke-drying effect that is one of natural purposes of the charcoal roaster.

1. A roaster, comprising:
a roaster box having a pair of guides fixed to an upper portion thereof;
a heat generation installed in the roaster box to generate heat;
a meat fixing means installed in the roaster box to fix meat to be cooked by heat generated from the heat generation device;
a carrying means mounted to the guides to be horizontally movable; and
a door mounted to the carrying means and moving horizontally together with the carrying means to open or close the roaster box.

2. The roaster according to claim 1, wherein the carrying means includes:
a pair of sliders mounted to the guides respectively to be horizontally slidable thereon; and
a door support coupled to the pair of sliders to move horizontally together with the sliders.

3. The roaster according to claim 2, wherein the door support includes:
a seating portion with a predetermined width on which each end of the door is seated; and
door restricting portions vertically formed on front and rear ends of the seating portion to restrict the door seated on the seating portion not to deviate in front or rear direction,
wherein the door is separated from the door support by behavior of lifting up the door.

4. The roaster according to claim 2,
wherein the guides are extended out of the roaster box by a predetermined length in a direction that the door is opened, and
wherein the sliders are supported by the extensions of the guide when the door is completely opened, whereby the door keeps a state horizontally supported to the guides when the door is completely opened.

5. The roaster according to claim 1,
wherein the door has a predetermined inner space where air is introduced in or discharged out.

6. The roaster according to claim 5,
wherein an air supply means for supplying air to the inner space of the door is installed to the roaster box.

7. The roaster according to claim 6, wherein the air supply means includes:
a blower fixed to the roaster box to generate airflow by means of an external power source; and
an air supply path for transferring the air generated from the blower toward the door,
wherein the door has a communication hole that communicates the inner space of the door with the air supply path when the door is completely closed, and a discharge hole that communicates the inner space of the door with an external air,
whereby, when the door is completely closed, the air supplied from the air supply means is supplied to the inner space of the door through the communication hole, and then discharged out through the discharge hole.

8. The roaster according to claim 7, wherein the door includes:
a quadrangular frame having an airflow space therein; and
upper and lower glasses coupled to upper and lower portions of the quadrangular frame,
wherein the inner space of the door is formed between the quadrangular frame and the upper and lower glasses,
wherein the communication hole is formed in a front side of the quadrangular frame, and the discharge hole is formed in a rear side of the quadrangular frame, and
wherein the air introduced through the communication hole passes the inner space of the door as well as the airflow space in the quadrangular frame and is then discharged out.

9. The roaster according to claim 7, further comprising:
a first sensor for sensing a state that the door is completely closed,
wherein the air supply means supplies air when the first sensor senses that the door is completely closed.

10. The roaster according to claim 5,
wherein at least an sidewall of the roaster box is composed of an inner box and an outer box, spaced apart from each other, and
wherein the air supply means supplies air into a space formed between the outer box and the inner box.

11. The roaster according to claim 10,
wherein an air supply tube is installed in the space formed between the outer box and the inner box in connection with the air supply means, and
wherein a plurality of discharge holes are formed in the air supply tube so as to discharge the air supplied from the air supply means into the space formed between the outer box and the inner box.

12. The roaster according to claim 11,
wherein a plurality of additional discharge holes are formed in the air supply tube toward the heat generation device, and
wherein a communication hole is formed in the inner box at a position corresponding to the additional discharge holes so that the air discharged from the additional discharge holes is supplied to the heat generation device.

13. The roaster according to claim 11,
wherein the air supply tube discharges air upward in the space between the inner box and the outer box, and
wherein at least two rows of holes are formed in the outer box in which one row of holes are formed at positions near the air discharge holes of the air supply tube and other row of holes are formed above one row of holes so that the air discharged from the air supply tube promotes flow of air that is introduced through one row of holes and discharged out through other row of holes.

14. The roaster according to claim 1,
wherein the heat generation device includes a burner for combusting gas to generate heat, and a charcoal ignited by the burner, and
wherein the roaster further comprises a gas supply unit for supplying gas to the charcoal arranged on the heat generation device.

15. The roaster according to claim 14, further comprising:
a second sensor for sensing a state that the door is completely opened,
wherein the gas supply unit supplies gas only when the second sensor senses that the door is completely opened.

16. The roaster according to claim 1,
wherein a heat guide plate inclined inwardly is installed in the roaster box at a position spaced upward from the heat generation device by a predetermined distance, and
wherein one end of the heat guide plate is inserted into the roaster box to be capable of being inserted in and drawn out from the roaster box so that the heat guide plate is not deformed due to expansion by heat, and a hook is formed on the other end of the heat guide plate so that the heat guide plate is coupled to the roaster box without unintended separation.

17. The roaster according to claim 1,
wherein the roaster box is installed to a table, and
wherein the door is inserted below an upper plate of the table when being opened.

18. The roaster according to claim 1,
wherein the heat generation device includes a pipe burner for combusting gas to give flames,
wherein a charcoal support having a charcoal placing region on which charcoal is placed is detachably installed on the pipe burner, and
wherein the roaster includes an air supply unit for supplying air in a lateral direction toward the charcoal placed on the charcoal support from a position laterally spaced apart from the charcoal support.

19. The roaster according to claim 1,
wherein at least two rows of gas holes are formed in an upper portion of the pipe burner at positions spaced apart from each other in right and left directions based on a vertical centerline of the pipe burner, and gas is injected in an inclined upper direction through the gas holes.

20. The roaster according to claim 19, the charcoal support includes:
seating portions seated on both ends of circumference of the pipe burner; and
a charcoal placing portion installed on the seating portions and positioned above the pipe burner when being installed to the pipe burner, the charcoal placing portion providing a charcoal placing region on which charcoal is placed,
wherein extensions are extended downward from both ends of the charcoal placing portion so that a width between the extensions gets wider downward, and
wherein the extensions cover the gas holes of the pipe burner at positions spaced upward from the gas holes by a predetermined distance.

21. The roaster according to claim 20,
wherein the charcoal support further includes barriers extended upward from right and left ends of the seating portions to prevent the charcoal placed on the charcoal placing portion from deviating unintentionally, and
wherein an airflow hole is formed in the barriers so that the air supplied from the air supply unit is oriented to the charcoal placed on the charcoal placing portion.

22. The roaster according to claim 18, wherein the air supply unit includes:
an air supply tube installed at a position laterally spaced apart from the charcoal support by a predetermined distance; and
a blower for supplying air to the air supply tube,
wherein a plurality of air discharge holes are formed in the air supply tube toward the charcoal support.

23. The roaster according to claim 22,
wherein at least a sidewall of the roaster box is composed of an inner box and an outer box, spaced apart from each other, and
wherein the air supply tube is installed in a space formed between the inner box and the outer box at a position laterally spaced apart from the charcoal support by a predetermined distance.

24. The roaster according to claim 23,
wherein a plurality of air discharge holes are formed in the air supply tube toward the charcoal support, and
wherein an airflow hole is formed in the inner box at a position corresponding to the air discharge holes so that the air discharged from the air discharge holes is supplied to the charcoal support.
